(19) United States
(12) Patent Application Publication
(10) Pub. No.: US 2024/0383358 A1
(43) Pub. Date: Nov. 21, 2024

(54) UNMANNED CHARGING DEVICE AND METHOD FOR A SMART LOGISTICS VEHICLE

(71) Applicants: HYUNDAI MOTOR COMPANY, Seoul (KR); KIA CORPORATION, Seoul (KR); HYUNDAI WIA CORPORATION, Changwon-si (KR)

(72) Inventors: Seoung Yeop Lee, Hwaseong-si (KR); Joo Young Chun, Seoul (KR); Ha Na Lee, Incheon (KR); Pan Keun Baek, Osan-si (KR); Jae Geon Lee, Seoul (KR); Ji Hwan Choi, Seoul (KR); Jung Hyeok Lim, Yongin-si (KR); Jong Woo Kim, Seoul (KR); Myeong Su Kim, Uiwang-si (KR)

(73) Assignees: HYUNDAI MOTOR COMPANY, Seoul (KR); KIA CORPORATION, Seoul (KR); HYUNDAI WIA CORPORATION, Changwon-si (KR)

(21) Appl. No.: 18/387,685

(22) Filed: Nov. 7, 2023

(30) Foreign Application Priority Data
May 19, 2023 (KR) 10-2023-0064827

(51) Int. Cl. B60L 53/36; B25J 5/00; B25J 11/00; B60L 53/30

(52) U.S. Cl. CPC B60L 53/36; B25J 5/007; B25J 11/008; B60L 53/305

(57) ABSTRACT

An unmanned charging device and method for a smart logistics vehicle are disclosed. The unmanned charging device includes a charging body configured to enable a mobile robot to dock therewith and having an inner space, and a charging terminal unit inserted into the inner space of the charging body and having a front support at a front side thereof, the charging terminal unit being configured to enable charging of the mobile robot. When the mobile robot approaches the charging body in response to reception of a charging request, a sensing unit of the mobile robot is supported by the front support, thereby causing the mobile robot to be adjusted in position. Docking of the mobile robot with the charging terminal unit is performed in a position-adjusted state of the mobile robot.

### CROSS-REFERENCE TO RELATED APPLICATION

This application claims the benefit of priority to Korean Patent Application No. 10-2023-0064827 filed on May 19, 2023 in the Korean Intellectual Property Office, the entire disclosure of which is incorporated herein by reference.

### BACKGROUND

### 1. Technical Field

The present disclosure relates to an unmanned charging device for a smart logistics vehicle, and more particularly to an unmanned charging device for a smart logistics vehicle capable of compensating for a position error of a mobile robot when a mobile robot performs docking, through shape modification of a charging terminal.

### 2. Description of the Related Art

Smart logistics vehicles are introduced not only in general logistics warehouses and factories, but also in smart factories for manufacturing items of different specifications using various parts, for flexible and efficient supply and transport of parts or the like.

Such a smart logistics vehicle is a concept including an autonomous mobile robot (AMR), an automated guided vehicle (AGV), an automated guided forklift, or the like. Such a smart logistics vehicle may perform movement and tasks under control of a control system.

In an autonomous mobile vehicle among smart logistics vehicles, a battery is mainly used as a drive power source. Conventionally, in most autonomous mobile vehicles, replacement of a battery is carried out in a direct replacement manner. However, there is inconvenience in that battery replacement is manually carried out. In order to eliminate such inconvenience, in recent years, an automatic charging system is mainly used, in which a mobile robot moves autonomously to a charging body installed at a certain location and performs connection and charging of a battery.

However, very complex control is required for accurate docking of a charger of the mobile robot with a charging terminal only through driving control of the mobile robot. For this reason, an increase in manufacturing costs of the mobile robot occurs. In practical cases, accordingly, a mechanical guide or design is mainly used to aid docking with a charging body. In this case, however, the charging terminal itself is designed to be adjustable in an angle thereof and, as such, there are problems in that the charging terminal has a complex structure, and is weak in terms of durability and requires maintenance and repair.

The above matters disclosed in this section are merely for enhancement of understanding of the general background of the disclosure and should not be taken as an acknowledgement or any form of suggestion that the matters form the related art already known to a person having ordinary skill in the art.

### SUMMARY

There is a need for a scheme capable of reducing a position error of a mobile robot when the mobile robot performs docking, through shape modification of a charging terminal, without angle adjustment of a charging terminal itself when the mobile robot docks with a charging terminal.

Therefore, the present disclosure has been made in view of the above problems, and it is an object of the present disclosure to provide an unmanned charging device for a smart logistics vehicle capable of compensating for a position error of a mobile robot when a mobile robot performs docking, through shape modification of a charging terminal.

Objects of the present disclosure are not limited to the above-described objects, and other objects of the present disclosure not yet described should be more clearly understood by those having ordinary skill in the art from the following detailed description.

In accordance with an aspect of the present disclosure, the above and other objects can be accomplished by the provision of an unmanned charging device for a smart logistics vehicle including a charging body configured to enable a mobile robot to dock therewith and having an inner space. The unmanned charging device also includes a charging terminal unit inserted into the inner space of the charging body and having a front support at a front side thereof. The charging terminal unit is configured to enable charging of the mobile robot. When the mobile robot approaches the charging body in response to reception of a charging request, a sensing unit of the mobile robot is supported by the front support, thereby causing the mobile robot to be adjusted in position. Docking of the mobile robot with the charging terminal unit is performed in a position-adjusted state of the mobile robot.

The charging body may include a position recognizer configured to recognize a position of the mobile robot. The position recognizer may recognize the sensing unit of the mobile robot, thereby recognizing the position of the mobile robot.

The charging body may include a display configured to display state information including at least one of operation state information of the charging body or a charged state of the mobile robot.

The charging body may include an anti-slip sheet formed at a bottom surface of the charging body. The anti-slip sheet extends outwards (i.e., forwards) and is configured to prevent slip of the mobile robot. The anti-slip sheet may sense whether or not the mobile robot is safely seated when the mobile robot approaches the charging body in response to reception of a charging request.

The front support may have a tapered shape gradually increasing in cross-sectional area as the front support extends in the inner space of the charging body in an inward direction.

The front support may have a tapered shape, and the sensing unit of the mobile robot may have an inverted tapered shape such that the sensing unit is adjusted in position in a state of being supported by the front support having the tapered shape.

The charging terminal unit may be spaced apart from the charging body in the inner space of the charging body, thereby forming a gap. When the sensing unit of the mobile robot is supported by the front support, the charging terminal unit may be tilted in a support direction towards the gap, thereby enabling the mobile robot to be adjusted in position.

The unmanned charging device may further include a cover attached to a front surface of the charging body while being open at a central portion thereof such that the cover is disposed at an outside of the charging terminal unit. The cover may regulate a tilted position of the charging terminal unit.

The unmanned charging device may further include a rear support provided in rear of the front support. The rear support may move to the gap together with the charging terminal unit when the sensing unit of the mobile robot is supported by the front support.

The rear support may have a tapered shape gradually increasing in cross-sectional area as the rear support extends in an outward direction in the inner space of the charging body.

The unmanned charging device may further include a compression spring provided in rear of the front support and elastically supported in the forward and rearward directions of the charging terminal unit, to urge the charging terminal unit in a forward direction. The compression spring may function to alleviate impact generated during docking of the mobile robot with the charging terminal unit.

The charging terminal unit may include a communication terminal configured to take charge of controller area network (CAN) communication of the charging body. The communication terminal may monitor a charged state of the mobile robot based on the CAN communication.

Start and end of charging of the mobile robot may be determined based on a charged state of the mobile robot monitored by the communication terminal.

The communication terminal may include an end having a protrusion shape, and the end of the communication terminal may be brought into close contact with a front surface of the mobile robot when the mobile robot docks with the charging body.

The unmanned charging device may further include a power supply terminal disposed over the communication terminal while being spaced apart from the communication terminal. The power supply terminal may enable the mobile robot to be charged when the mobile robot docks with the charging terminal unit.

In accordance with various embodiments of the present disclosure as described above, it may be possible to compensate for a position error of the mobile robot through shape modification of the charging terminal unit and, as such, unmanned operation may be efficiently achieved.

In addition, errors between contacts of the charging terminal unit and the mobile robot are prevented and, as such, problems such as heat generation, fire, and degradation of charging efficiency may be minimized.

The effects of the embodiments of the present disclosure are not limited to the above-described effects and other effects that are not described herein may be readily understood by those having ordinary skill in the art from the following description and accompanying drawings.

### BRIEF DESCRIPTION OF THE DRAWINGS

The above and other objects, features and other advantages of the present disclosure should be more clearly understood from the following detailed description taken in conjunction with the accompanying drawings, in which:

FIG. 1 is a block diagram showing an example of a configuration of a smart factory applicable to embodiments of the present disclosure;

FIG. 2 is a block diagram showing an example of a control system configuration applicable to embodiments of the present disclosure;

FIG. 3 is a block diagram showing an example of a smart logistics vehicle configuration applicable to embodiments of the present disclosure;

FIG. 4 is a perspective view showing an example of an exterior of a smart logistics vehicle applicable to embodiments of the present disclosure;

FIG. 5 is a flowchart showing an example of a traveling procedure of the smart logistics vehicle applicable to embodiments of the present disclosure;

FIG. 6 is a perspective view of an unmanned charging device for the smart logistics vehicle according to an embodiment of the present disclosure;

FIG. 7 is a front view showing a configuration of a charging terminal unit according to an embodiment of the present disclosure;

FIGS. 8 and 9 are lateral sectional views showing a charging terminal unit according to an embodiment of the present disclosure;

FIG. 10 is a view showing a sensing unit of a mobile robot according to an embodiment of the present disclosure;

FIG. 11 is a bottom sectional view showing a charging terminal unit according to an embodiment of the present disclosure;

FIG. 12 is a sectional view showing a state in which a charging terminal unit according to an embodiment of the present disclosure has been moved to gaps in accordance with tilting thereof;

FIG. 13 is a view showing an exterior of a charging terminal unit according to an embodiment of the present disclosure; and

FIG. 14 is a flowchart showing an unmanned charging method for a smart logistics vehicle according to an embodiment of the present disclosure.

### DETAILED DESCRIPTION

Hereinafter, embodiments of the present disclosure are described in detail with reference to the accompanying drawings, and the same or similar elements are designated by the same reference numerals regardless of the numerals in the drawings and redundant description thereof has been omitted. The suffixes “module” and “unit” of elements herein are used for convenience of description and thus can be used interchangeably and do not have any distinguishable meanings or functions. In describing the present disclosure, moreover, a detailed description has been omitted when a specific description of publicly known technologies to which the disclosure pertains is judged to obscure the gist of the present disclosure. In addition, it should be noted that the accompanying drawings are merely illustrated to easily explain the spirit of the disclosure, and therefore, should not be construed as limiting the spirit of the disclosure to the accompanying drawings. On the contrary, the disclosure is to cover all modifications, equivalents, and alternatives falling within the spirit and scope of the disclosure as defined by the claims.

Although terms including an ordinal number, such as first or second, may be used to describe a variety of constituent elements, the constituent elements are not limited to the terms, and the terms are used only for the purpose of discriminating one constituent element from other constituent elements.

It should be understood that, when one element is referred to as being “connected to” or “coupled to” another element, one element may be “connected to” or “coupled to” another element via a further element although one element may be directly connected to or directly coupled to another element. On the other hand, it should be understood that, when an element is referred to as being “directly connected to” or “directly coupled to” another element, there is no intervening element present.

As used in the description of the disclosure and the appended claims, the singular forms are intended to include the plural forms as well, unless context clearly indicates otherwise.

It should be further understood that the terms “comprises” and/or “comprising,” or “includes” and/or “including” when used in this specification, specify the presence of stated features, regions, integers, steps, operations, elements, and/or combinations thereof, but do not preclude the presence or addition of one or more other features, regions, integers, steps, operations, elements, components, and/or combinations thereof.

The term “unit” or “control unit” used in specific terminology of an internal configuration of a smart logistics vehicle or a control system is only a term widely used for designation of a controller for controlling a particular function and, as such, does not mean a generic functional unit. For example, the controller may include a modem/transceiver configured to communicate with another controller or a sensor, for control of a function to be performed thereby, a memory configured to store an operating system, logic commands, input/output information, etc., and at least one processor configured to execute discrimination, calculation, determination, etc. required for control of the function to be performed.

When a component, device, element, or the like of the present disclosure is described as having a purpose or performing an operation, function, or the like, the component, device, or element should be considered herein as being “configured to” meet that purpose or to perform that operation or function.

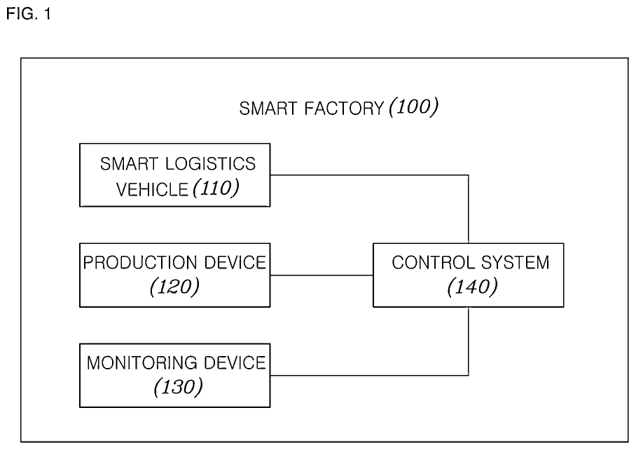

First, a configuration of a smart factory in which a smart logistics vehicle according to an embodiment of the present disclosure is disposed and operated is described with reference to FIG. 1.

FIG. 1 is a block diagram showing an example of a configuration of a smart factory applicable to embodiments of the present disclosure.

Referring to FIG. 1, the smart factory, which is designated by reference numeral “100”, may include a smart logistics vehicle 110, a production device 120, a monitoring device 130, and a control system 140.

In accordance with a process for producing products and a target production rate, the smart factory 100 may include a plurality of smart logistics vehicles 110, a plurality of production devices 120, and a plurality of monitoring devices 130. Hereinafter, each constituent element of the smart factory 100 is described.

First, the smart logistics vehicle 110 may include an autonomous mobile robot (hereinafter simply referred to as an “AMR”), an automated guided vehicle (hereinafter simply referred to as an “AGV”), and an automated guided forklift. In accordance with an operating plan of the smart logistics vehicle 110, one kind of an AGV and an AMR may be operated in the smart factory 100, or both the AGV and the AMR may be operated in a single smart factory 100.

The AGV may perform an operation (movement, direction change, stop, and the like) required in the smart factory 100 by recognizing and tracing a guide installation disposed on a floor in order to guide the AGV. In this example, the guide installation may mean an optically-recognizable marker (a spot, a 2D code, and the like), a tag recognizable in a non-contact manner in a near field (for example, a near field communication (NFC) tag, a radio frequency identification (RFID) tag, and the like), a magnetic strip, a wire, and the like, which are illustrative and do not limit the guide installation thereto. The guide installation may be continuously disposed in plural on the floor, or may be discontinuously disposed in plural on the floor such that plural guide installations are spaced apart from one another. Since the AGV performs a desired operation basically through recognition and tracing of the guide installation, the AGV requires, prior to operation thereof, that the guide installation be previously installed. Accordingly, when it is necessary to move the AGV along a new path or to correct a current path, setting of a new guide installation or correction of the existing guide installation is physically required. In addition, generally, when an obstacle on a path or therearound is sensed, the AGV stops until the sensed obstacle disappears or the AGV is subjected to separate control, because the AGV does not escape from a predetermined path by virtue of the guide installation. In association with operation of the AGV, the control system 140 should control the AGV based on the guide installation and, as such, may transmit, to the AGV, commands meaning, for example, “traveling from the current position until a third marker is recognized”, “changing a heading direction by 90° when the third marker is recognized”, and the like on an individual-command basis or on a mission basis. The mission includes a plurality of commands (for example, collection, supply, charge, patrol, and the like).

The AMR may determine (i.e., measure) the current position through sensing of surroundings, and may be remarkably distinguished from the AGV in that path planning of the AMR is possible using position measurement and a map. In the case in which the AMR and the control system 140 share a coordinate-compatible map, accordingly, the control system 140 may control the AMR in such a manner that the control system 140 designates a desired path to the AMR based on coordinates. In addition, when an obstacle is sensed during traveling, the AMR may set a bypass path by itself, and may then return to the original path after bypassing the obstacle. The function that the control system 140 sets the path of the AMR by one or more layover coordinates may be referred to as “global path planning”, and the function that the AMR sets a travel path or a bypass path among bypass coordinates according to global path planning may be referred to as “local path planning”.

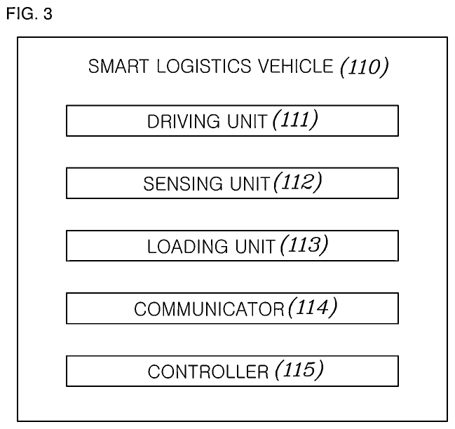

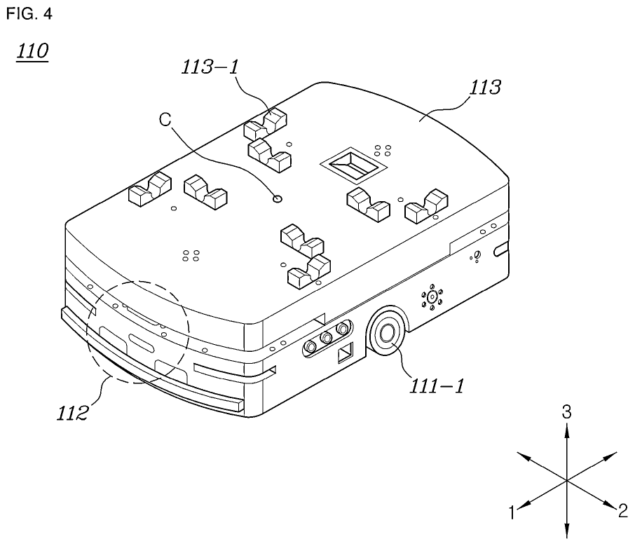

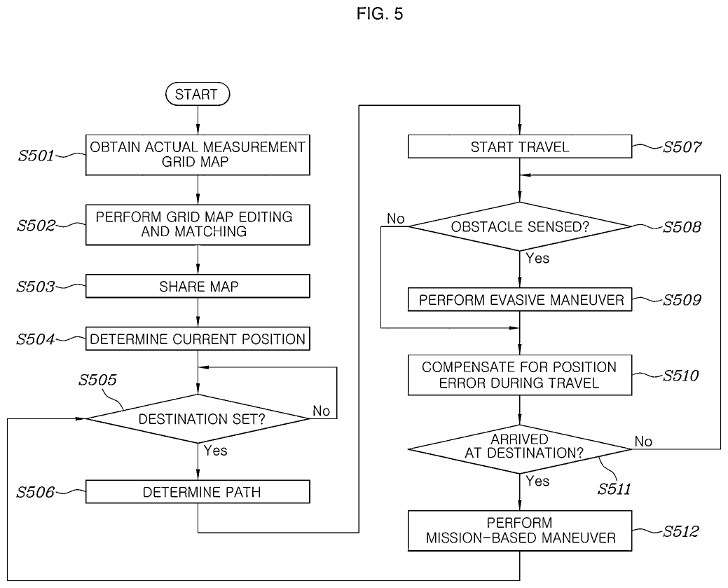

A detailed configuration of the smart logistics vehicle 110 is described below with reference to FIGS. 3 and 4, and a travel control procedure of the AMR is described below with reference to FIG. 5.

The production device 120 may mean a device (for example, a robot arm, a conveyer belt, or the like) configured to perform a process of producing products in the smart factory 100, and may broadly mean a device disposed to aid execution of a mission such as entrance and exit of the smart logistics vehicle 110 or the like when the production process is executed by a person. The device disposed to aid execution of the mission may be a device configured to sense a state of a designated position where the smart logistics vehicle 110 unloads or collects a pallet carried thereby, a device configured to determine a process progress rate, and/or a device configured to prevent entrance and exit into or from a predetermined zone, and the like, without being limited thereto.

For example, the production device 120 may be controlled through a programmable logic controller (PLC), and may perform communication with the control system 140 in association with process progress.

The monitoring device 130 may perform a function for obtaining information for determination of a situation in the smart factory 100, and transmitting the obtained information to the control system 140. For example, the monitoring device 130 may include a camera, a proximity sensor, or the like, without being limited thereto.

The control system 140 may perform communication with the above-described constituent elements 110, 120, and 130, thereby obtaining information required for operation of the smart factory 100 or controlling the constituent elements 110, 120, and 130. For example, the control system 140 may perform allocation of the smart logistics vehicle 110, path setting, mission allocation, process management on a product basis, material management, and the like.

In accordance with an embodiment, the control system 140 may include a local control system (an AMR/AGV control system (ACS)) configured to control surrounding process equipment based on a position of the AGV/AMR and to perform a mission-based control for the AGV/AMR, and an integrated control system (a mobile robot integrated monitoring system (MoRIMS)) configured to control two or more local control systems in an integrated manner. The integrated control system may perform control of states and paths of all smart logistics robots 110, setting of logistics flows, and traffic in the smart factory 100 in association with each of a plurality of local control systems. For example, when a plurality of local control systems (ACS) is provided for smart logistics robots manufactured by different manufacturers or manufactured to have different types, respectively, the integrated control system may perform integrated control for prevention of collision such as analysis of a bottleneck level in an intersection/overlap zone, travel acceleration/deceleration control, bypass path re-creation, and the like, through heterogeneous traffic distribution control based on information obtained through the plurality of local control systems (ACS).

In addition, the integrated control system may include a manufacturing execution system (MES) as a core of upper control thereof. The MES may operate in linkage with an advanced planning & scheduling system (APS).

Of course, in addition to the above-described constituent elements 110, 120, 130, and 140 of the smart factory 100, a device configured to achieve mutual communication among the above-described constituent elements 110, 120, 130, and 140, such as a beacon, a repeater, an access point (AP), or the like, a charger configured to achieve recharging of the smart logistics vehicle 110, a storage space for storage or stacking of parts, a space for storage of finished products or intermediate products, a signal lamp, a breaker, a waiting space for the smart logistics vehicle 110 in an idle state, and the like may be appropriately disposed in the smart factory 100.

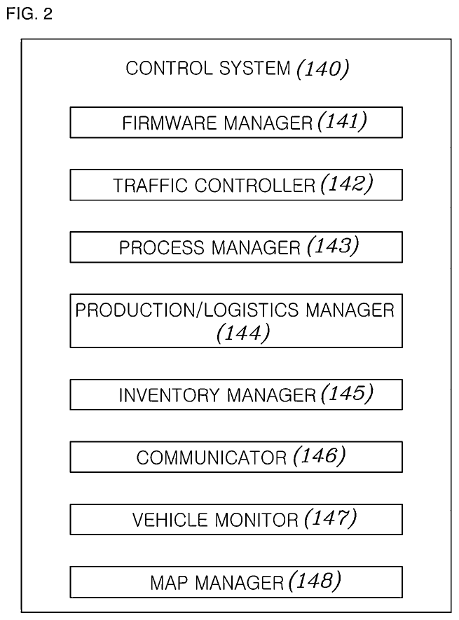

Hereinafter, a configuration of the control system 140 applicable to embodiments of the present disclosure is described with reference to FIG. 2.

FIG. 2 is a block diagram showing an example of a control system configuration applicable to embodiments of the present disclosure. Constituent elements shown in FIG. 2 are mainly associated with embodiments of the present disclosure and, as such, a greater or smaller number of constituent elements than that of FIG. 2 may be included in the control system 140 when the control system 140 is practically implemented.

Referring to FIG. 2, the control system 140 may include a firmware manager 141, a traffic controller 142, a process manager 143, a production/logistics manager 144, an inventory manager 145, a communicator 146, a vehicle monitor 147, and a map manager 148.

The firmware manager 141 may obtain a latest firmware of the smart logistics vehicle 110 through the communicator 146, and may transmit the obtained latest firmware to the smart logistics vehicle 110, thereby enabling the smart logistics vehicle 110 to perform firmware update. Accordingly, the firmware manager 141 maintains the firmware of the smart logistics vehicle 110 in a latest state.

The traffic controller 142 may control a signal lamp and a breaker based on a path of the smart logistics vehicle 110, and may again calculate a path of the smart logistics vehicle 110 in accordance with traffic.

The process manager 143 may define processes on a product basis, and may manage a mission such as a process progress rate, a progress position, and the like.

The production/logistics manager 144 may allocate the smart logistics vehicle 110 on a mission basis.

The inventory manager 145 may manage a material position and material quantity on a material basis, and such information may be useful for more efficient process operation, for example, control of the smart logistics vehicle 110 to depart for a destination before the time when assembly/consumption of materials is sensed, for pick-up or collection of a pallet.

The communicator 146 may perform communication not only with internal constituent elements of the smart factory 100 such as the smart logistics vehicle 110, the production device 120, and the monitoring device 130, but also with an external object such as a firmware update server or the like.

The vehicle monitor 147 may monitor a position, a path, a battery state, a communication state, and a power train state of each smart logistics vehicle 110. In this example, the path is a concept including a global path based on waypoints and a real-time local path. In addition, the battery state may include voltage, current, temperature, peak values of voltage and current, a state of charge (SOC), a state of health (SOH), and the like. The communication state may include information about a currently activated communication protocol (Wi-Fi or the like), a connected AP, a distance from the AP, a channel in use, and the like. In addition, the power train state may include load, temperature, RPM, and the like of a driving system.

In addition, the vehicle monitor 147 may identify a mission, an operation mode, and a firmware version currently allocated to each smart logistics vehicle 110.

The map manager 148 may obtain map data of a grid map type from the AMR of the smart logistics vehicle 110, which obtains the map data while traveling in the smart factory 100, and may provide a tool enabling a factory manager to edit the obtained map data. Through editing of the map data, a zone where the smart logistics vehicle 110 performs one or more predetermined operations when the smart logistics vehicle 110 enters the zone, a virtual lane, an intersection, an entrance prohibition zone, and the like may be set. However, this is illustrative, and embodiments of the present disclosure are not limited thereto. In addition, the map manager 148 may distribute an initial grid map obtained by one smart logistics vehicle 110 through actual travel to another smart logistics vehicle 110.

Smart logistics vehicles are described below with reference to FIGS. 3 and 4.

FIG. 3 is a block diagram showing an example of a smart logistics vehicle configuration applicable to embodiments of the present disclosure.

Referring to FIG. 3, the smart logistics vehicle 110 may include a driving unit 111, a sensing unit 112, a loading unit 113, a communicator 114, and a controller 115. Hereinafter, the above-described constituent elements are described.

The driving unit 111 may include a drive source, a wheel, a suspension, and the like participating in movement, steering, and stop of the smart logistics vehicle 110. For the drive source, an electric motor configured to receive electric power from a battery (not shown) internally equipped in the smart logistics vehicle 110 may be used. The wheel may include one or more drive wheels configured to receive drive force from the drive source, and driven wheels configured to rotate in accordance with movement of a vehicle body without receiving drive force. In accordance with an embodiment, when a plurality of drive wheels is provided, the drive source may be matched with the drive wheels on an individual drive wheel basis such that rotation of each drive wheel may be independently controlled. In this case, rotation directions of different ones of the drive wheels may become different from one another and, as such, steering may be achieved through rotation of the vehicle body without a separate steering means. At least a part of the driven wheels may be configured as a caster type wheel. However, this is illustrative, and embodiments of the present disclosure are not limited thereto.

The sensing unit 112 is configured to sense an environment around the smart logistics vehicle 110, an operation state of the smart logistics vehicle 110, and the like. The sensing unit 112 may include at least one of a 2D laser scanner (for example, a LiDAR), a 3D vision (stereo) camera, a multi-axis gyro sensor, an acceleration sensor, a wheel encoder, or a proximity sensor.

The encoder may output information capable of determining how much the wheel has rotated, using light emitted from a light emitting element (for example, a photodiode). For example, the encoder may count, for a unit time, the number of slits disposed in a circumferential direction at the wheel or a disc rotating together with the wheel. The controller 115 may perform odometry for estimating a displacement by analyzing a position displacement per time based on data obtained through an encoder and a gyro sensor. Of course, the displacement estimated based on the encoder data may be different from an actual displacement due to slip or wear (wheel radius variation). Accordingly, upon execution of odometry, the controller 115 may compensate information collected from the wheel and the gyro sensor for noise and errors through a predetermined algorithm (for example, an extended Kalman filter (EKF)) and, as such, may output results approximating an actual value. Such odometry may be particularly useful when localization using a 2D laser scanner, which is described below, is impossible.

The 2D laser scanner may irradiate a laser onto surroundings through a rotating reflector, and may sense a signal returning thereto after being reflected, thereby scanning a surrounding environment. In this case, the 2D laser scanner may analyze an intensity of the reflected signal and a time difference between irradiation and reception, thereby outputting sensing results having the form of a point cloud.

The 3D vision camera may calculate a time difference between two cameras spaced apart from each other by a predetermined distance, i.e., a distance to an object based on a pixel distance between images photographed through respective cameras. In this case, the 3D vision camera may be provided with a texture projector configured to project infrared light having a predetermined pattern, in order to achieve sensing of even a planar object having a single color (for example, a white wall) or the like.

Generally, the 2D laser scanner is used for mapping, navigation, object recognition, and the like, and the 3D vision camera may be used for navigation, in particular, obstacle avoidance. Of course, this is illustrative, and embodiments of the present disclosure are not limited thereto.

The loading unit 113 is a unit configured to load an article to be transported. The loading unit 113 may take the form of an upper plate disposed at an upper portion of a vehicle body, or a table, a lift, a turntable rotatable about a vertical axis, a forklift, or a conveyor disposed at the upper plate, or a combination thereof. In the case of the forklift, telescopic and tilting functions may be supported, similarly to a general forklift.

The communicator 114 may perform communication with other constituent elements in the smart factory 100, for example, the production device 120, the control system 140, and the like, and may also support communication among smart logistics vehicles 110. The communicator 114 may also communicate with the charger during execution of a charging mission.

The controller 115 is a subject performing whole control for the above-described constituent elements 111, 112, 113, and 114. The controller 115 may perform determination of a current mission, a current position, and a destination, path planning, control for the loading unit, and the like, based on information obtained from the control system 140 through the communicator 114.

FIG. 4 is a perspective view showing an example of an exterior of a smart logistics vehicle applicable to embodiments of the present disclosure.

Referring to FIG. 4, an example of an AMR is shown as the smart logistics vehicle 110. The vehicle body of the smart logistics vehicle 110 may have a track type planar shape having a longitudinal axis extending in a first axial direction. One drive wheel 111-1 may be disposed at a central portion of the vehicle body in the first axial direction, and may also be disposed at one side of the vehicle body in a second axial direction. The other drive wheel (not shown) may be disposed at the other side of the vehicle body in the second axial direction such that the other drive wheel is opposite to the one drive wheel 111-1. Such drive wheel arrangement may be referred to as “differential drive (DD)”. Although not shown in FIG. 4, two or more driven wheels may be disposed under the vehicle body. In this case, when the two drive wheels rotate in the same direction at the same speed, the vehicle body may move forwards or rearwards in the first axial direction. On the other hand, when the two drive wheels rotate in opposite directions at the same speed, the vehicle body may rotate with reference to a rotation axis passing through a planar center C of the vehicle body while extending in a third axial direction. In addition, the sensor unit 112 may be disposed at a front portion of the vehicle body, and the loading unit 113 may be disposed at a top portion of the vehicle body. The loading unit 113 may be configured to vertically reciprocate in the third axial direction. A rack, a tray, or the like may be fixed to an upper surface of the loading unit 113 through a guide 113-1.

Of course, the above-described AMR form of FIG. 4 is illustrative, and an AGV may have a form similar to that of FIG. 4, or the AMR may have a form different from that of FIG. 4.

A traveling procedure of the smart logistics vehicle 110 of FIG. 4 is described below with reference to FIG. 5.

FIG. 5 is a flowchart showing an example of a traveling procedure of the smart logistics vehicle 110 applicable to embodiments of the present disclosure. In FIG. 5, for convenience, it is assumed that the smart logistics vehicle 110 is an AMR enabling position measurement and setting of a local path.

Referring to FIG. 5, the AMR may first obtain an actual measurement grid map through a LiDAR while traveling in the smart factory 100 (S501).

When the AMR transmits the obtained grid map to the control system 140, grid map editing and matching procedures may be performed in the map manager 148 of the control system 140 (S502). In this example, the editing procedure may include a procedure for setting the above-described various zones in the above-described grid map, a procedure for allocating a cost on a code basis, and the like. Cost allocation may be carried out such that a higher cost is allocated when the AMR becomes closer to an obstacle or an entrance prohibition zone, in order to prevent the AMR from moving to a zone around the obstacle or the entrance prohibition zone. This is because, when the AMR sets a local path, the AMR selects a set of cells having a lowest cost among waypoints.

In addition, the map matching procedure may mean a procedure for matching coordinates among a CAD map used in design of the smart factory 100, an actual measurement grid map (a LIDAR map), and a topology map subjected to an editing procedure.

Thereafter, the control system 140 may enable all AMRs in the smart factory 100 to share the topology map, through the communicator 146 (S503).

A subsequent procedure may be a procedure applied to each AMR in an individual manner.

The AMR may obtain sensor data and a map and, as such, may perform localization on the map (S504). For example, the AMR may localize the current position by comparing a surrounding terrain obtained through a LIDAR with the map based on a feature point.

The control system 140 may allocate a mission by selecting a particular AMR. To the mission, one or more waypoints generally determined through global path planning may be allocated. Each waypoint may be defined by coordinates on the map, and information about a direction of the AMR (i.e., heading) at the defined coordinates may also be included therein. In accordance with such mission allocation, a destination may be set in the AMR (“Yes” in S505), and the AMR may perform local path planning among waypoints based on costs of the topology map (S506).

When a route is determined, the AMR starts travel (S507). When an obstacle is sensed through the sensing unit 112 during travel of the AMR (“Yes” in S508), the AMR performs an evasive maneuver by performing local path navigation in order to bypass the sensed obstacle (S509). If necessary, the control system 140 may update the mission of the AMR in accordance with the evasive maneuver or failure of the evasive maneuver.

In addition, the AMR may compensate for a positional error during travel thereof through the above-described odometry scheme until the AMR arrives at a destination (S510).

When the AMR arrives at the destination (S511), the AMR may then perform mission-based maneuver (S512). For example, the AMR may determine whether or not conditions for enabling the AMR to enter a particular process zone should be cleared, may collect an empty pallet at the destination, or may drop an article stacked on the loading unit 113.

In accordance with an embodiment of the present disclosure, an unmanned charging device for a smart logistics vehicle, which is capable of compensating for a position error of a mobile robot through shape modification of a charging terminal when the mobile robot performs docking, is proposed.

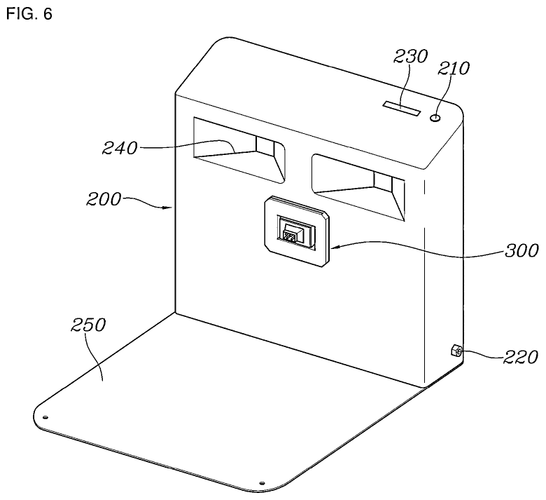

Hereinafter, an unmanned charging device for a smart logistics vehicle according to an embodiment of the present disclosure is described with reference to FIG. 6.

FIG. 6 is a perspective view of an unmanned charging device for the smart logistics vehicle according to an embodiment of the present disclosure.

Referring to FIG. 6, the unmanned charging device for the smart logistics vehicle 100 according to an embodiment of the present disclosure may include a charging body 200 and a charging terminal unit 300. Hereinafter, the constituent elements of the unmanned charging device are described.

First, the charging body 200 is configured to enable a mobile robot to dock therewith. The charging body 200 is formed with an inner space at an interior thereof while being formed with a power supply 220, a power switch 210, a display 230, a position recognizer 240, and an anti-slip sheet 250 at an exterior thereof. As shown in FIG. 6, the power supply 220 may be provided at a side surface of the charging body 200, and may be configured to receive electric power output from outside of the charging body 200, to covert the electric power into predetermined power, and then to supply the converted power to the charging body 200. In accordance with whether or not power should be supplied to the unmanned charging device, the user may switch the power switch 210 on/off. In an ON state of the power switch 210, power is supplied through the power supply 220. In addition, the display 230 may display information as to an operation state of the charging body 200 and a charged state of the mobile robot. The display 230 may externally display state information including an ON/OFF state and a failure state of the charging body 200, and whether or not the mobile robot in a docking state has been discharged, in a visible manner. Accordingly, the user may check a state of the charging body 200 or a state of the mobile robot by recognizing the information displayed on the display 230. In addition, the position recognizer 240 may recognize a sensing unit 112 of the mobile robot, thereby recognizing a position of the mobile robot. The position recognizer 240 may include a LIDAR sensor of the mobile robot and, as such, may enable the mobile robot to be charged in a state of accurately docking with the charging terminal unit 300 in accordance with the recognized position.

In addition, the anti-slip sheet 250 may be formed at a bottom surface of the charging body 200, to extend outwards (i.e., forwards). The anti-slip sheet 250 may prevent slip of the mobile robot when the mobile robot enters for docking thereof and, as such, the mobile robot is fixed to the charging body 200 without slipping even upon generation of impact during docking. In addition, the anti-slip sheet 250 may sense whether or not the mobile robot is safely seated when the mobile robot approaches the charging body 200 in response to reception of a charging request, and may also check whether or not a docking position of the mobile robot is correct.

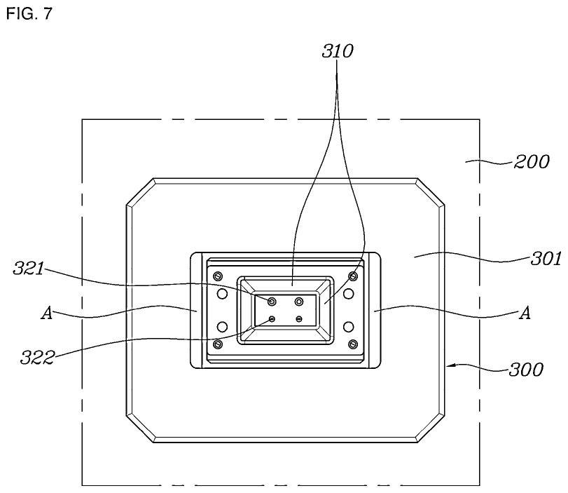

Hereinafter, the charging terminal unit 300 is described in detail with reference to FIG. 7.

FIG. 7 is a front view showing a configuration of the charging terminal unit 300 according to an embodiment of the present disclosure.

Referring to FIG. 7, the charging terminal unit 300 may be provided to extend from an outside of a central portion of the charging body 200 into the inner space of the charging body 200, in order to enable the mobile robot to dock with the charging terminal unit 300 from outside of the charging terminal unit 300.

The charging terminal unit 300 may be provided to be inserted into the inner space of the charging body 200, and may be formed with a front support 310 at a front side thereof. In more detail, when the mobile robot approaches the charging body 200 in response to reception of a charging request, the sensing unit 112 of the mobile robot may be supported by the front support 310 and, as such, a position of the mobile robot may be adjusted. The mobile robot may then additionally enter the charging terminal unit 300 in a state in which the position of the mobile robot has been adjusted and, as such, docking of the mobile robot with the charging terminal unit 300 may be achieved.

In this case, the front support 310 may be formed to have a tapered shape gradually increasing in cross-sectional area as the front support 310 extends in the inner space of the charging body 200 in an inward direction. The front support 310 may have a tapered shape at all surfaces thereof, i.e., an upper surface, a lower surface, and opposite side surfaces thereof, such that the sensing unit 112 of the mobile robot may perform docking while sliding along the front support 310.

In addition, a communication terminal 322 and a power supply terminal 321 is described below.

The communication terminal 322 may take charge of controller area network (CAN) communication of the charging body 200. The communication terminal 322 may be provided in plural and, as such, may monitor a charged state of the mobile robot based on CAN communication, thereby providing a charging function to the charging body 200. In addition, the communication terminal 322 may set a reference value in association with the monitored battery charging state of the mobile robot, and may determine start and end of charging of the mobile robot based on the set reference value. When charging is required because the charged state of the mobile robot is lower than a predetermined reference value, charging may begin. On the other hand, when charging is not required because the charged state of the mobile robot is higher than the predetermined reference value, charging may be ended (or not started). In addition, the communication terminal 322 may be formed to have an end having a protrusion shape. Through the protrusion shape of the end, the charging body 200 may be directly brought into close contact with a front surface of the mobile robot when the mobile robot docks with the charging body 200 and, as such, communication between the charging body 200 and the mobile robot may be smoothly carried out. The power supply terminal 321 may be provided to be disposed over (i.e., above) the communication terminal 322 while being spaced apart from the communication terminal 322. The power supply terminal 321 may enable the mobile robot to be charged when the mobile robot docks with the charging terminal unit 300. When docking is released in accordance with completion of charging of the mobile robot, the communication terminal 322 and the power supply terminal 321 may be separated.

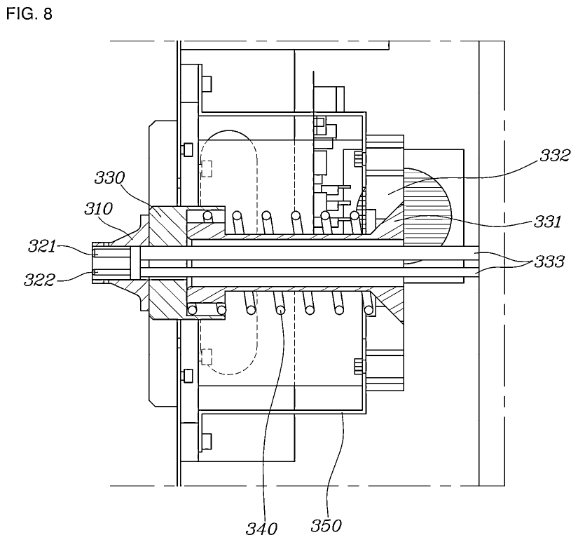

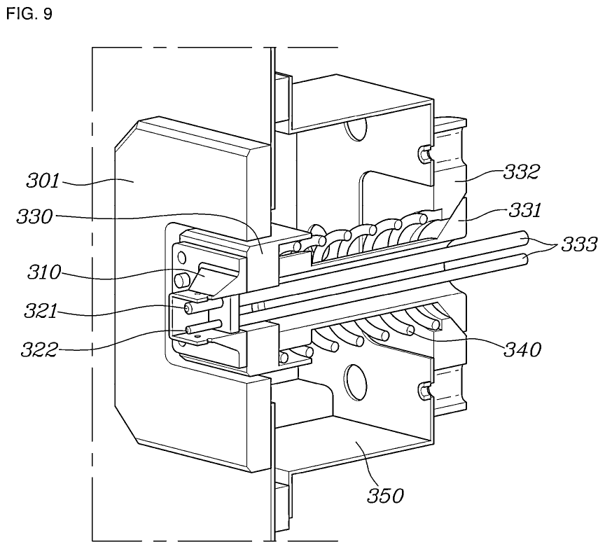

A configuration of the charging terminal unit 300 is described in more detail below with reference to FIGS. 8 and 9.

FIGS. 8 and 9 are lateral sectional views showing the charging terminal unit 300 according to an embodiment of the present disclosure.

Referring to FIGS. 8 and 9, a cover 301 is formed around the charging terminal unit 300, and the charging terminal unit 300 may be constituted by the front support 310, a block 330, a compression spring 340, a rear support 331, a wiring 333, a housing 332, and a bracket 350. The cover 301 is attached to a front surface of the charging body 200, and is open at a central portion thereof such that the cover 301 is disposed at an outside of the charging terminal unit 300. When the charging terminal unit 300 is tilted as the charging terminal unit 300 is pushed in a docking direction of the mobile robot, i.e., a left or right direction, the cover 301 may regulate a maximally tilted position of the charging terminal unit 300 at the outside of the charging terminal unit 300. Accordingly, the mobile robot is prevented from sliding laterally during docking thereof, and docking of the mobile robot may also be continuously carried out at a particular point.

In addition, the block 330 may be provided in rear of the front support 310, to absorb load of the mobile robot and then to transmit the load in forward and rearward directions of the charging terminal unit 300. The compression spring 340 may be provided in rear of the front support 310, and may be elastically supported in the forward and rearward directions of the charging terminal unit 300, to urge the charging terminal unit 300 in a forward direction. The compression spring 340 may function to alleviate impact generated during docking of the mobile robot with the charging terminal unit 300. The rear support 331, to which the load of the mobile robot is transmitted, is provided inside the compression spring 340. The wiring 333 may be disposed inside the rear support 331, and may be connected to the communication terminal 322 and the power supply terminal 321 and, as such, may be connected to the charging body 200. The bracket 350 may be provided at an outside of the rear support 331. The bracket 350 may cover the charging terminal unit 300 in the inner space of the charging body 200 and, as such, may protect the charging terminal unit 300 from external impact.

The rear support 331 and the housing 332 are described below.

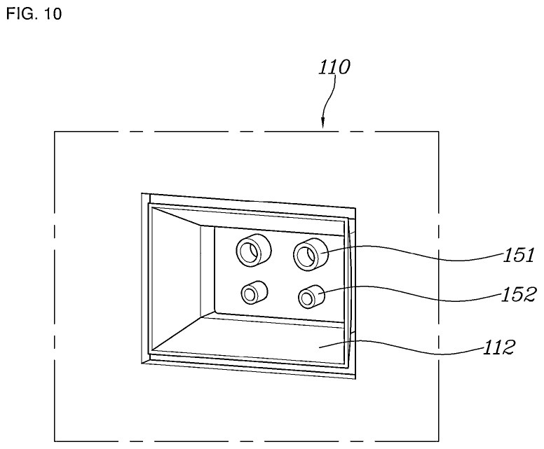

FIG. 10 is a view showing the sensing unit 112 of the mobile robot according to an embodiment of the present disclosure.

Referring to FIG. 10, the sensing unit 112 of the mobile robot may be formed to have an inverted tapered shape such that the sensing unit 112 may be adjusted in position in a state of being supported by the front support 310 having the tapered shape. The sensing unit 112 of the mobile robot may be formed to have a shape gradually increasing in cross-sectional area as the sensing unit 112 extends in an outward direction (i.e., away from a interior of the mobile robot to an outer surface of the mobile robot) while engaging with the front support 310 having a tapered shape at all surfaces thereof, i.e., the upper surface, the lower surface, and the opposite side surfaces thereof. Similar to the charging terminal 300, the sensing unit 112 may be formed with a power connector 151 and a communication connector 152 at a central portion thereof. The power connector 151 and the communication connector 152 may be connected to the power supply terminal 321 and the communication terminal 322, respectively, and, as such, power connection and communication connection of the mobile robot may be achieved.

Hereinafter, operation of the charging terminal unit 300 during docking thereof with the charging terminal unit 300 of the mobile robot is described.

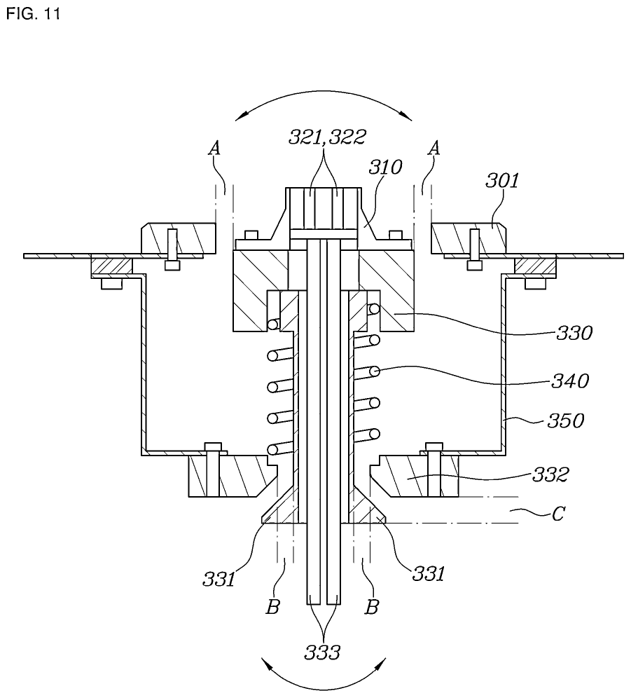

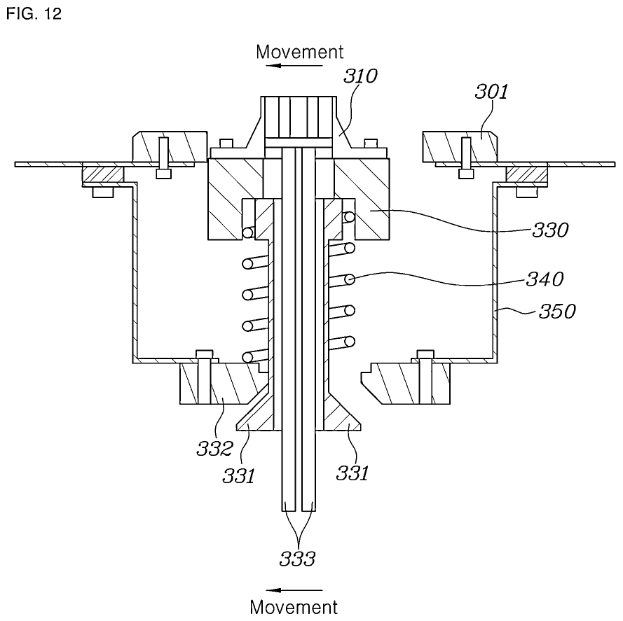

FIG. 11 is a bottom sectional view showing the charging terminal unit according to an embodiment of the present disclosure. FIG. 12 is a sectional view showing a state in which the charging terminal unit 300 according to an embodiment of the present disclosure has been moved to gaps A and B in accordance with tilting thereof.

Referring to FIG. 11, the charging terminal unit 300 may be spaced apart from the charging body 200 in the inner space of the charging body 200, thereby forming gaps A and B. When the sensing unit 112 of the mobile robot is supported by the front support 310, the charging terminal unit 300 may be tilted in a support direction and, as such, may be moved to the gap A. Thus, a position of the mobile robot may be adjusted.

In more detail, the charging terminal unit 300 may first be tilted in a movement direction of the mobile robot in accordance with a weight of the charging terminal unit 300, and may then be moved to one side while being aligned with the mobile robot in a state in which movement of the mobile robot to the charging body 200 is stopped. The rear support 331 may be provided in rear of the front support 310. When the sensing unit 112 of the mobile robot is supported by the front support 310, the rear support 331 may be moved to the gap B together with the charging terminal unit 300.

In this case, a rear end of the rear support 331 may be formed to have a tapered shape gradually increasing in cross-sectional area as the rear end extends in an outward direction into the inner space of the charging body 200. In accordance with this structure, the charging terminal unit 300 may enable tilting in left and right directions, corresponding to the shape of the front support 310. Such a structure may function to determine horizontal and vertical positions of the charging terminal unit 300 when there is no load. For such a function, a function of the housing 332 is advantageous. The housing 332 may be provided outside the rear end of the rear support 331, and may be attached to the bracket 350. The housing 332 may be formed to have an inverted tapered shape such that the rear support 331 may return to an original position in horizontal and vertical directions of the charging terminal unit 300 when no load is applied to the rear support 331.

By virtue of the above-described gaps and the structure enabling the charging terminal unit 300 to be moved to the gaps in accordance with docking of the mobile robot, it may be possible to compensate for a position error of the mobile robot and, as such, unmanned operation may be efficiently achieved.

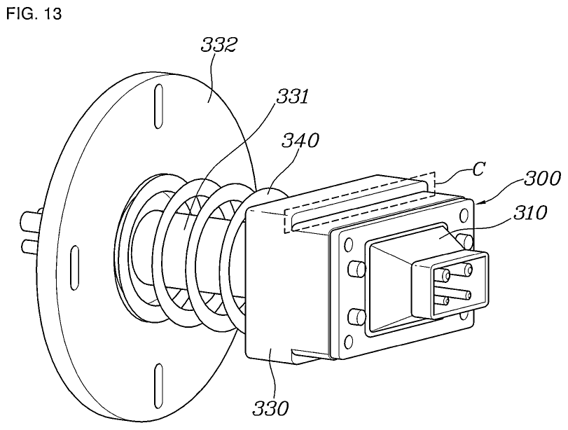

FIG. 13 is a view showing an exterior of the charging terminal unit 300 according to an embodiment of the present disclosure. Referring to FIG. 13, the block 330 constituting the charging terminal unit 300 may form a stepped structure C in rear of the front support 310. A front side of the block 330 may be configured to conform to a rear surface of the front support 310, and a rear side of the block 330 may be configured to be wider than the front side of the block 330. Accordingly, the block 330 may completely receive a load transmitted from the mobile robot while securing durability against the load.

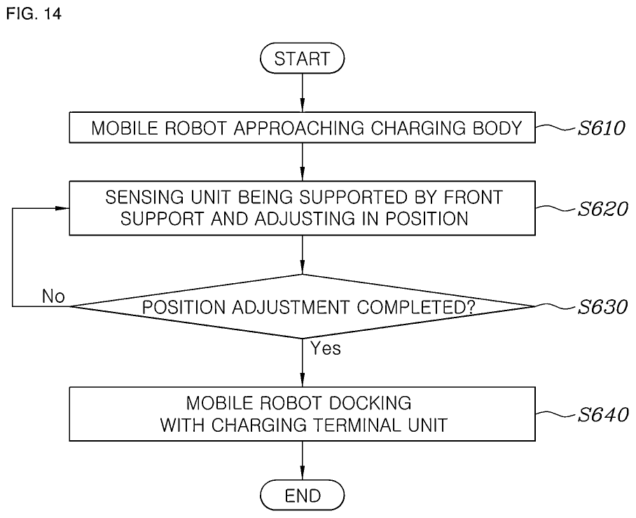

An unmanned charging method for a smart logistics vehicle according to an embodiment of the present disclosure is described below in conjunction with the above-described configuration of the unmanned charging device for the smart logistics vehicle with reference to FIG. 14.

FIG. 14 is a flowchart showing the unmanned charging method for the smart logistics vehicle according to an embodiment of the present disclosure.

The unmanned charging method for the smart logistics vehicle is briefly described below with reference to FIG. 14. First, the mobile robot may approach the charging body 200 (S610). Thereafter, the sensing unit 112 of the mobile robot is supported by the front support 310 and, as such, a position of the mobile robot may be adjusted (S620). When position adjustment of the mobile robot is subsequently completed (“Yes” in S630), the mobile robot may perform docking with the charging terminal unit 300 (S640).

Consequently, the unmanned charging device for the smart logistics vehicle according to an embodiment of the present disclosure may compensate for a position error of the mobile robot through shape modification of the charging terminal unit and, as such, unmanned operation may be efficiently achieved. In addition, error between contacts of the charging terminal unit and the mobile robot are prevented and, as such, problems such as heat generation, fire, and degradation of charging efficiency may be minimized.

The present disclosure as described above may be embodied as computer-readable code, which can be written on a program-stored recording medium. The recording medium that can be read by a computer includes all kinds of recording media, on which data that can be read by a computer system is written. Examples of recording media that can be read by a computer may include a hard disk drive (HDD), a solid state drive (SSD), a silicon disk drive (SDD), a read only memory (ROM), a random access memory (RAM), a CD-ROM, a magnetic tape, a floppy disk, an optical data storage, and the like. Accordingly, it should be apparent to those having ordinary skill in the art that various modifications and variations can be made in the present disclosure without departing from the spirit or scope of the disclosure. Thus, it is intended that the present disclosure cover the modifications and variations of this disclosure provided they come within the scope of the appended claims and their equivalents.

Although the embodiments of the present disclosure have been disclosed for illustrative purposes, those having ordinary skill in the art will appreciate that various modifications, additions and substitutions are possible, without departing from the scope and spirit of the disclosure as disclosed in the accompanying claims.

What is claimed is:

1. An unmanned charging device for a smart logistics vehicle, the unmanned charging device comprising:
a charging body configured to enable a mobile robot to dock therewith, the charging body having an inner space; and
a charging terminal unit inserted into the inner space of the charging body, the charging terminal unit having a front support at a front side thereof, the charging terminal unit being configured to enable charging of the mobile robot,
wherein, when the mobile robot approaches the charging body in response to reception of a charging request, a sensing unit of the mobile robot is supported by the front support, thereby causing the mobile robot to be adjusted in position, and wherein docking of the mobile robot with the charging terminal unit is performed in a position-adjusted state of the mobile robot.

2. The unmanned charging device according to claim 1, wherein:
the charging body comprises a position recognizer configured to recognize a position of the mobile robot; and
the position recognizer recognizes the sensing unit of the mobile robot, thereby recognizing the position of the mobile robot.

3. The unmanned charging device according to claim 1, wherein the charging body comprises a display configured to display state information comprising at least one of operation state information of the charging body or a charged state of the mobile robot.

4. The unmanned charging device according to claim 1, wherein:
the charging body comprises an anti-slip sheet at a bottom surface of the charging body, the anti-slip sheet extending outwards and configured to prevent slip of the mobile robot; and
the anti-slip sheet senses whether or not the mobile robot is safely seated when the mobile robot approaches the charging body in response to reception of the charging request.

5. The unmanned charging device according to claim 1, wherein the front support has a tapered shape gradually increasing in cross-sectional area as the front support extends in the inner space of the charging body in an inward direction.

6. The unmanned charging device according to claim 1, wherein the front support has a tapered shape, and the sensing unit of the mobile robot has an inverted tapered shape such that the sensing unit is adjusted in position in a state of being supported by the front support having the tapered shape.

7. The unmanned charging device according to claim 1, wherein:
the charging terminal unit is spaced apart from the charging body in the inner space of the charging body, thereby forming a gap; and
when the sensing unit of the mobile robot is supported by the front support, the charging terminal unit is tilted in a support direction towards the gap, thereby enabling the mobile robot to be adjusted in position.

8. The unmanned charging device according to claim 7, further comprising:
a cover attached to a front surface of the charging body while being open at a central portion thereof such that the cover is disposed at an outside of the charging terminal unit,
wherein the cover regulates a tilted position of the charging terminal unit.

9. The unmanned charging device according to claim 1, further comprising:
a rear support provided in rear of the front support, the rear support moving to the gap together with the charging terminal unit when the sensing unit of the mobile robot is supported by the front support.

10. The unmanned charging device according to claim 9, wherein the rear support has a tapered shape gradually increasing in cross-sectional area as the rear support extends in an outward direction in the inner space of the charging body.

11. The unmanned charging device according to claim 9, further comprising:
a compression spring provided in rear of the front support and elastically supported in the forward and rearward directions of the charging terminal unit, the compression spring being configured to urge the charging terminal unit in a forward direction,
wherein the compression spring is configured to alleviate impact generated during docking of the mobile robot with the charging terminal unit.

12. The unmanned charging device according to claim 1, wherein:
the charging terminal unit comprises a communication terminal configured to take charge of controller area network (CAN) communication of the charging body; and
the communication terminal monitors a charged state of the mobile robot based on the CAN communication.

13. The unmanned charging device according to claim 12, wherein start and end of charging of the mobile robot is determined based on a charged state of the mobile robot monitored by the communication terminal.

14. The unmanned charging device according to claim 12, wherein the communication terminal includes an end having a protrusion shape, wherein the end of the communication terminal is brought into close contact with a front surface of the mobile robot when the mobile robot docks with the charging body.

15. The unmanned charging device according to claim 12, further comprising:
a power supply terminal disposed over the communication terminal while being spaced apart from the communication terminal,
wherein the power supply terminal enables the mobile robot to be charged when the mobile robot docks with the charging terminal unit.

16. An unmanned charging method for a smart logistics vehicle, the smart logistics vehicle comprising a charging body configured to enable a mobile robot to dock therewith and having an inner space, the smart logistics vehicle also comprising a charging terminal unit inserted into the inner space of the charging body and having a front support at a front side thereof, the charging terminal unit being configured to enable charging of the mobile robot, the unmanned charging method comprising:
receiving a charging request by the mobile robot, thereby causing the mobile robot to approach the charging body;
supporting a sensing unit of the mobile robot by the front support, thereby adjusting a position of the mobile robot; and
docking the mobile robot with the charging terminal unit in a position-adjusted state of the mobile robot.

17. The unmanned charging method according to claim 16, wherein adjusting a position of the mobile robot comprises spacing the charging terminal unit from the charging body in the inner space of the charging body, thereby forming a gap, and tilting the charging terminal unit in a support direction of the sensing unit of the mobile robot when the sensing unit of the mobile robot is supported by the front support, to move the charging terminal unit to the gap, thereby adjusting a position of the mobile robot.
